(19) United States
(12) Patent Application Publication
(10) Pub. No.: US 2002/0177650 A1
(43) Pub. Date: Nov. 28, 2002

(54) Rubber formulations for tire

(76) Inventors: Makio Mori, Hiratsuka-shi (JP); Takeshi Hotaka, Hiratsuka-shi (JP)

Correspondence Address: David T. Nikaido, RADER, FISHMAN & GRAUER, PLLC, Suite 501, 1233 20th Street NW, Washington, DC, 20036, US

(21) Appl. No.: 10/101,693

(22) Filed: Mar. 21, 2002

(30) Foreign Application Priority Data
Mar. 28, 2001 (JP) 2001-93575(PAT. A

(51) Int. Cl. C08K 3/04; C08K 3/34

(52) U.S. Cl. 524/492; 524/495; 523/218

(57) ABSTRACT

A rubber composition for a tire tread containing 100 parts by weight of a diene-based rubber, 2 to 50 parts by weight of precipitated silica, 1 to 25 parts by weight of heat expandable microcapsules, or 1 to 25 parts by weight of heat expandable microcapsules and 1 to 20 parts by weight of heat expandable graphite, and 0.1 to 10 parts by weight of a polysiloxane compound having repeating units of formula (I):

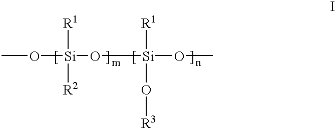

wherein R¹ independently indicates a methyl group, ethyl group or phenyl group, R² independently indicates hydrogen or an organic group, R³ independently indicates an alkyl group or acyl group, m is 0 or an integer of 1 or more and n is an integer of 1 or more and having a number average molecular weight of 200 to 100,000.

### BACKGROUND OF THE INVENTION

1. Filed of the Invention

The present invention relates to a rubber composition for tire, more specifically relates to a rubber composition for tire having a stable quality and superior performance on ice, without an influence by the environmental condition during the processing.

2. Description of the Related Art

A rubber composition having a superior frictional force on ice provided by blending heat expandable microcapsules into a diene-based rubber has already been proposed in, for example, Japanese Unexamined Patent Publication (Kokai) No. 11-35736, but this formulation has the problem that the heat expandability is liable to decrease, when used together with a silica in the formulation. This has been believed due to the fact that the silica and the moisture contained in the rubber formulation react to produce silanol groups which act on the shells of the microcapsules. Therefore, a technique for stabilizing the heat expandability of microcapsules in the formulation with large amount of silica therein is desired, especially in an environment with high humidity.

Silica has a large number of silanol groups formed on the outer shells thereof due to adsorption of moisture in the atmosphere. Various types of coupling agents are used for making such silica capable of mixing with nonpolar ingredients. Among these, Si 69 (bis-[3-(triethoxysilyl)-propyl]tetrasulfide) commercially available from Degussa is often used. However, Si 69 has six ethoxy groups in a molecule and, therefore, even after reacting with silica, ethoxy groups remain at the side opposite to the reaction sites (that is, the surface side of the silica particles). These ethoxy groups react with the moisture in the atmosphere to again form silanol groups which destabilize the heat expandability of the microcapsules.

### SUMMARY OF THE INVENTION

Accordingly, an object of the present invention is to provide a rubber composition which does not leave the above silanol groups intact after mixing even when blending heat expandable microcapsules together with silica in a diene-based rubber, which is not adversely affected by the environment during the processing, and which gives a stable quality and superior performance on ice.

In accordance with the present invention, there is provided a rubber composition for a tire tread comprising 100 parts by weight of a diene-based rubber, 2 to 50 parts by weight of precipitated silica, 1 to 25 parts by weight of heat expandable microcapsules and 0.1 to 10 parts by weight of a polysiloxane compound having a repeating unit of formula (I):

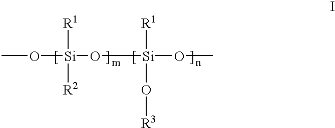

wherein R¹ independently indicates a methyl group, ethyl group or phenyl group, R² independently indicates hydrogen or an organic group, R³ independently indicates an alkyl group or acyl group, m is 0 or an integer of 1 or more, and n is an integer of 1 or more and having a number average molecular weight of 200 to 100,000.

In accordance with the present invention, there is also provided a rubber composition for a tire tread comprising 100 parts by weight of a diene-based rubber, 2 to 50 parts by weight of precipitated silica, 1 to 25 parts by weight of heat expandable microcapsules, 1 to 20 parts by weight of heat expandable graphite and 0.1 to 10 parts by weight of a polysiloxane compound having a repeating unit of formula (I):

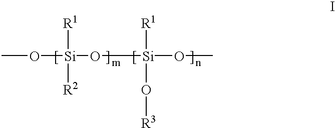

wherein R¹ indicates independently a methyl group, ethyl group or phenyl group, R² indicates independently hydrogen or an organic group, R³ indicates independently an alkyl group or acyl group, m is 0 or an integer of 1 or more and n is an integer of 1 or more and having a number average molecular weight of 200 to 100,000.

### DESCRIPTION OF PREFERRED EMBODIMENTS

In this specification and in the claims which follow, reference will be made to singular forms “a,” “an” and “the” include plural referents unless the context clearly dictates otherwise.

The present inventors proceeded with studies to improve the unstable qualities due to the effects of the environment when trying to obtain a rubber composition for a tire superior in performance on ice by blending heat expandable microcapsules together with silica into a diene-based rubber and, as a result, found that, since a polysiloxane compound having the specific structure of the above formula (I) reacts with silanol groups present in the system and does not leave alkoxyl groups such as ethoxy groups at the opposite sides of the reaction sites, it is possible to eliminate residual polar groups and possible to effectively improve the heat expandability of the microcapsules.

The diene-based rubber blended as the main ingredient into the vulcanizable rubber composition according to the present invention includes, for example, any diene-based rubber generally blended into various types of rubber compositions heretobefore such as natural rubber (NR), polyisoprene rubber (IR), various styrene-butadiene copolymer rubbers (SBR), various polybutadiene rubbers (BR), acrylonitrile-butadiene copolymer rubber (NBR), butyl rubber (IIR). These diene-based rubbers may be used alone or in any blend thereof. Note that these diene-based rubbers may also be used in the form of a blend with, for example, ethylene-propylene copolymer rubbers (EPR, EPDM). The diene-based rubber used in the present invention preferably has an average value of the glass transition temperature of not more than −55° C., more preferably −70 to −100° C. If the glass transition temperature thereof is higher than −55° C., the rubber is susceptible to brittle fractures, while the tire can be used in a cold area.

According to the present invention, 2 to 50 parts by weight, preferably 3 to 20 parts by weight, of precipitated silica are blended into 100 parts by weight of the diene-based rubber. The precipitated silica useable in the present invention includes any commercially available precipitated silica generally blended into various rubber compositions heretobefore. The amount of the silica blended is preferably determined with a consideration of the propriety of tanδ of the rubber.

According to the present invention, the heat expandable microcapsules, or the heat expandable microcapsules and heat expandable graphite, are blended into 100 parts by weight of the diene-based rubber. The amount of the heat expandable microcapsules blended is 1 to 25 parts by weight, preferably 3 to 10 parts by weight, based upon 100 parts by weight of the diene-based rubber. If the amount blended is too small, the effect of improvement of the performance on ice undesirably becomes insufficient, while conversely if too large, the abrasion resistance performance of the rubber is undesirably decreased. The amount of the heat expandable graphite blended is 1 to 20 parts by weight, preferably 3 to 10 parts by weight, based upon 100 parts by weight of the diene-based rubber. If the amount of the heat expandable graphite is too small, the effect of improvement of the performance on ice is undesirably decreased, while conversely if too large, the mechanical strength of the rubber is undesirably decreased. Note that, when using both the heat expandable microcapsules and the heat expandable graphite, it is preferable that the total amount blended not be more than 25 parts by weight. If the total amount blended is too large, the mechanical strength is undesirably decreased.

The heat expandable microcapsules are plastic resin particles containing a liquid which vaporizes, decomposes, or chemically reacts to generate a gas, due to the heat. The heat expandable microcapsules can be expanded by heat, at a temperature of at least the expansion starting temperature, normally a temperature of 140 to 190° C., to form shells comprised of the thermoplastic resin containing a gas sealed within the inside of the resin. The size of the expandable thermoplastic resin particles is preferably 5 to 300 μm, more preferably 10 to 200 μm. Such heat expandable thermoplastic resin particles are commercially available under the product names, for example, “Expancell 091DU-80”, “Expancell 092DU-120”, etc. from EXPANCEL of Sweden, or the product names “Matsumoto Microsphere F-85”, “Matsumoto Microsphere F-100”, etc. from Matsumoto Yushi-Seiyaku of Japan.

The thermoplastic resins forming the shells of the gas-filled thermoplastic resin particles are those having, for example, an expansion starting temperature of at least 100° C., preferably at least 120° C., and a maximum expansion temperature of at least 150° C., preferably at least 160° C., are preferably used. Examples of such a thermoplastic resin are a polymer of (meth)acrylonitrile or a copolymer with a high content of (meth)acrylonitrile. The other monomers or comonomers in the case of the above copolymers include, for example, a halogenated vinyl, halogenated vinylidene, styrene-based monomer, (meth)acrylate-based monomer, vinyl acetate, butadiene, vinylpyridine, chloroprene, etc. Note that the above thermoplastic resin may also be cross-linked with, for example, divinylbenzene, ethyleneglycol di(meth)acrylate, triethyleneglycol di(meth)acrylate, trimethylolpropane tri(methy)acrylate, 1,3-butyleneglycol (meth)acrylate, allyl (meth)acrylate, triacryl formal, triallyl isocyanulate, or another cross-linking agent. Regarding the mode of cross-linking, no cross-linking is preferable, but it is also possible to be partially cross-linked to such an extent that the properties are not impaired as a thermoplastic resin. The liquid capable of vaporizing, decomposing, or chemically reacting to generate a gas by heat are for example, a liquid, for example, hydrocarbons such as n-pentane, isopentane, neopentane, butane, isobutane, hexane, petroleum ether; chlorinated hydrocarbons such as methyl chloride, methylene chloride, dichloroethylene, trichloroethane, trichloroethylene.

The expandable graphite used in the present invention may be a conventional products heretofore used. For example, a crystalline compound maintaining the lamellar or laminer structure of carbon obtained by treating natural flake-shaped graphite, thermally decomposed graphite, kish graphite, etc. with an inorganic acid such as concentrated sulfuric acid or nitric acid etc. and an oxidizing agent such as concentrated nitric acid, perchlorate, permanganate, or bichromate etc. to produce a graphite interlamellar compound, may be mentioned. Further, it is preferable to use an acid treated expandable graphite followed by neutralizing with a basic compound. Examples of the basic compound are ammonia, an alkali metal compound, an alkaline earth metal compound, an aliphatic lower amine, etc. Example of the aliphatic lower amine are an alkylamine, monomethylamine, dimethylamine, trimethylamine, ethylamine, propylamine, butylamine, etc. Examples of the alkali metal compound or alkaline earth metal compound are a hydroxide, oxide including compound oxides and complex oxides, carbonate, hydrocarbonate (or bicarbonate), or organic acid salt of potassium, sodium, calcium, barium, magnesium, etc. Examples of the organic acid salt are, a formate, acetate, propionate, butyrate, oxalate, malonate, succinate, tartarate, and citrate.

The rubber composition according to the present invention may be blended with, as a rubber reinforcing agent, any carbon black ordinarily formulated into rubber compositions. Further, it is also possible to use carbon black treated, on the surface thereof, with silica. The amount of the carbon black is preferably 20 to 70 parts by weight, more preferably 30 to 60 parts by weight, based upon 100 parts by weight of the rubber. If the amount of the carbon black is too small, the rubber cannot be sufficiently reinforced, and therefore, for example, the abrasion resistance is liable to deteriorate, while conversely if too large, the hardness is liable to become too high or the processability is liable to fall. The carbon black used in the present invention has a nitrogen specific surface area (N₂SA) of preferably at least 70 m²/g, more preferably 80 to 150 m²/g, and a dibutylphthalate (DBP) oil absorption of preferably at least 95 ml/100 g, more preferably 100 to 115 ml/100 g.

According to the present invention, since a polysiloxane having a repeating structural unit of the above formula (I) is formulated into the rubber composition, the alkoxysiloxane reacts with the silanol groups to cover the surface of the silica particles, the problems caused in the prior art do not arise, and an increase in the viscosity due to the cohesion or polarity of the silanol groups or wasteful consumption of polar additives such as the vulcanization accelerator can be effectively suppressed.

The polysiloxane of the above formula (I) formulated into the rubber composition in accordance with the present invention, as explained above, has to be a polymer (or oligomer) having an alkoxysilyl group or an acyloxysilyl group capable of reacting with a silanol group and having a size covering the surface of the silica particles and exhibiting a lubricating effect, for example, a number average molecular weight of 200 to 100000, preferably 500 to 50000. Therefore, in the repeating units of the above formula (I), the presence of the ≡Si—O—R³ group is essential. Therefore, n is at least 1, preferably 5 to 1000, while m may be zero, but a hydrogen group or other organic group is also possible. The polysiloxane is a known substance. For example, it can generally be produced as follows:

That is, a compound having the polysiloxane structure of formula (I) may be synthesized by reacting a corresponding polyalkyl hydrogensiloxane with an alcohol or a carboxylic acid in the presence of a catalyst. Examples of the polyalkyl hydrogen siloxane are as follows:

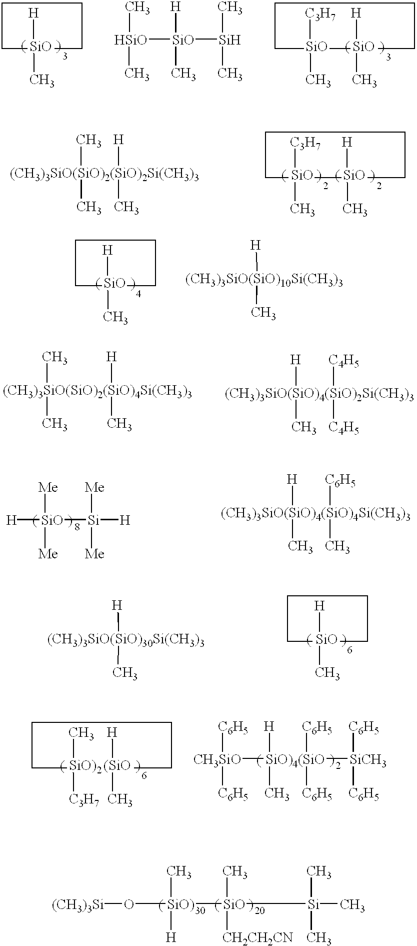

Examples of the alcohol are methanol, ethanol, propanol, butanol, pentanol, heptanol, octanol, octadecanol, phenol, benzyl alcohol, and also ethyleneglycol monomethylether, diethyleneglycol monomethylether, and other alcohols having oxygen atoms. Examples of the carboxylic acid are acetic acid, propionic acid, palmitic acid, stearic acid, myristic acid, etc. As the catalyst, chloroplatinic acid, a platinum-ether complex, a platinum-olefin complex, PdCl₂ (PPh₃)₂, RhCl₂ (PPh₃)₂, tin octylate, zinc octylate, or an acid or basic catalyst may be used.

The polysiloxane used in the present invention is, as mentioned above, not particularly limited in the end or terminal group thereof. This is determined by the type of the starting material used for production. For example, it may be a trimethylsilyl group, methyldiphenylsilyl group, triphenylsilyl group, or also an organic group.

In the formula (I), as mentioned above, R¹ indicates a methyl group, ethyl group, or phenyl group. R² indicates a hydrogen group or organic group, while an organic group indicates, for example, CH₃, C₂H₅, a styrene residual group, divinylbenzene residual group, limonene residual group, butadiene residual group, isoprene residual group, etc. R³ indicates a C₁ to C₃₆ alkyl group such as CH₃, C₂H₅, C₁ to C₃₆ acyl group, etc.

The rubber composition according to the present invention may further contain therein, in addition to the above essential ingredients, a vulcanization or cross-linking agent, a vulcanization or cross-linking accelerator, various types of oils, an antioxidant, a reinforcing agent, a filler, a plasticizer, a softener, and other various types of additives generally blended into general rubber. The formulation may be mixed and vulcanized by a general method to make a composition. The amounts of these additives may be made the general amounts of the prior art insofar as they do not run counter to the object of the present invention.

### EXAMPLES

The present invention will now be further illustrated by, but is by no means limited to, the following Examples.

### Comparative Examples 1 to 4 and Examples 1 to 3

Preparation of Samples

A 1.7 liter closed type Bambury mixer was used to mix rubber, carbon black and other compounding agents other than the vulcanization accelerator, sulfur, heat expandable graphite and microspheres in the amounts shown in Table I (parts by weight) together with or without the polysiloxane compound for 5 minutes, then the sulfur, vulcanization accelerator, heat expandable graphite, and microspheres were blended in an open roll.

Evaluation of Physical Properties

A sheet of each of the compounds obtained above and vulcanized was attached to a flat columnar rubber base and measured for coefficient of friction on ice by an inside drum type ice friction tester. The measurement was conducted at measurement temperatures of −3.0° C. and −1.5° C., a load of 5.5 kg/cm³, and a drum speed of 25 km/h. The results are shown by indices using the value of Comparative Example 1 as 100. The larger the value, the higher the frictional force on ice.

TABLE I

| | Comp. | Comp. | | Comp. | | Comp. | |
|---|---|---|---|---|---|---|---|
| | Ex. 1 | Ex. 2 | Ex. 1 | Ex. 3 | Ex. 2 | Ex. 4 | Ex. 3 |
| Formulation (parts | | | | | | | |
| by weight | | | | | | | |
| RSS#3 *1 | 50 | 50 | 50 | 50 | 50 | 50 | 50 |
| NIPOL 1220 *2 | 50 | 50 | 50 | 50 | 50 | 50 | 50 |
| SHOBLACK N220 *3 | 55 | 55 | 55 | 55 | 55 | 55 | 55 |
| SANTOFLEX 6PPD *4 | 1 | 1 | 1 | 1 | 1 | 1 | 1 |
| Zinc oxide no. 3 *5 | 3 | 3 | 3 | 3 | 3 | 3 | 3 |
| Stearic acid *6 | 1 | 1 | 1 | 1 | 1 | 1 | 1 |
| Aromatic oil *7 | 30 | 30 | 30 | 30 | 30 | 30 | 30 |
| SANTOCURE NS *8 | 1.5 | 1.5 | 1.5 | 1.5 | 1.5 | 1.5 | 1.5 |
| Sulfur *9 | 2 | 2 | 2 | 2 | 2 | 2 | 2 |
| MACROSPHERE F100D *10 | — | 10 | 10 | 10 | 10 | — | — |
| ZERUMA *11 | — | — | 4 | — | 4 | — | 4 |
| GRAFGuard 160-80N *12 | — | — | — | 10 | 10 | 10 | 10 |
| Performance | | | | | | | |
| Frictional force on | 100 | 112 | 124 | 122 | 134 | 108 | 118 |
| ice (−3.0° C.) (Index) | | | | | | | |
| Frictional force on | 100 | 123 | 141 | 143 | 155 | 120 | 131 |
| ice (−1.5° C.) (Index) | | | | | | | |

Footnote of Table I
*1 RSS#3: natural rubber, glass transition temperature = −74° C.
*2 Nipol 1220: butadiene rubber made by Nippon Zeon., glass transition temperature = −101° C.
*3 SHOBLACK N220: carbon black made by Showa Cabot, N₂SA: 111 m²/g, DBP oil absorption: 111 ml/100 g
*4 SANTOFLEX 6PPD: antioxidant made by Flexsis
*5 Zinc oxide # 3: made by Seido Chemical
*6 Stearic acid: made by NOC
*7 Aromatic oil: made by Fuji Kosan
*8 SANTOCURE NS: vulcanization accelerator made by Flexsis
*9 Sulfur: made by Karuizawa Refinery
*10 Microsphere F100D: heat expandable microcapsules made by Matsumoto Yushi
*11 Zeruma: ethoxymethyl hydrogen polysiloxane made by Nippon Unicar
*12 GRAFGuard 160-80N: heat expandable graphite made by UCAR Graphtech

1. A rubber composition for a tire tread comprising 100 parts by weight of a diene-based rubber, 2 to 50 parts by weight of precipitated silica, 1 to 25 parts by weight of heat expandable microcapsules and 0.1 to 10 parts by weight of a polysiloxane compound having a repeating unit of formula (I): 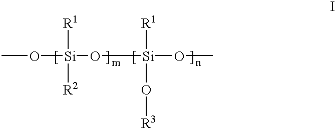
wherein R¹ independently indicates a methyl group, ethyl group or phenyl group, R² independently indicates hydrogen or an organic group, R³ independently indicates an alkyl group or acyl group, m is 0 or an integer of 1 or more and n is an integer of 1 or more and having a number average molecular weight of 200 to 100,000.

2. A rubber composition as claimed in claim 1, wherein an average value of a glass transition temperature of said diene-based rubber is −55° C. or less.

3. A rubber composition as claimed in claim 1, wherein carbon black having a nitrogen specific surface area (N₂SA) of at least 70 m²/g and a dibutyl phthalate (DBP) oil absorption of at least 95 ml/100 g is further contained in 100 parts by weight of the diene-based rubber in an amount of 2 to 70 parts by weight.

4. A rubber composition for a tire tread comprising 100 parts by weight of a diene-based rubber, 2 to 50 parts by weight of precipitated silica, 1 to 25 parts by weight of heat expandable microcapsules, 1 to 20 parts by weight of a heat expandable graphite and 0.1 to 10 parts by weight of a polysiloxane compound having a repeating unit of formula (I): 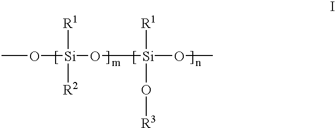
wherein R¹ independently indicates a methyl group, ethyl group or phenyl group, R² independently indicates hydrogen or an organic group, R³ independently indicates an alkyl group or acyl group, m is 0 or an integer of 1 or more and n is an integer of 1 or more and having a number average molecular weight of 200 to 100,000.

5. A rubber composition as claimed in claim 4, wherein an average value of a glass transition temperature of said diene-based rubber is −55° C. or less.

6. A rubber composition as claimed in claim 4, wherein carbon black having a nitrogen specific surface area (N₂SA) of at least 70 m²/g and a dibutyl phthalate (DBP) oil absorption of at least 95 ml/100 g is further contained in 100 parts by weight of the diene-based rubber in an amount of 2 to 70 parts by weight.
